(19) United States
(12) Patent Application Publication
(10) Pub. No.: US 2006/0082672 A1
(43) Pub. Date: Apr. 20, 2006

(54) Filtering digital images

(75) Inventor: Elad Peleg, Nahariya (IL)

Correspondence Address: DR. MARK FRIEDMAN LTD.;c/o Bill Polkinghorn, 9003 Floring Way, Upper Marloboro, MD, 20772, US

(73) Assignee: M-Systems Flash Disk Pioneers Ltd.

(21) Appl. No.: 11/181,867

(22) Filed: Jul. 15, 2005

Related U.S. Application Data
(60) Provisional application No. 60/618,490, filed on Oct. 14, 2004.

(51) Int. Cl. H04N 5/222

(52) U.S. Cl. 348/333.01

(57) ABSTRACT

A digital camera used for photographing and storing in memory photographic images. The memory is attached to the digital camera. The camera includes a quality grading mechanism which assigns quality values respectively to the stored image based on parameters such as focus quality, brightness, contrast, and image size. An expected improvement of the value is calculated by applying a correction algorithm to the stored images. The digital camera includes an input mechanism which triggers the camera to display the images in an new order based on one or more of the quality values. Alternatively, one or more of the photographic images may be deleted based on the quality values.

### CROSS REFERENCE TO RELATED APPLICATIONS

This application claims the benefit from U.S. provisional application 60/618,490 filed 14-Oct. 2004 by the present inventor.

### FIELD AND BACKGROUND OF THE INVENTION

The present invention relates to digital photography. Specifically, photographic images taken with a digital camera are saved on a memory card or stored in the camera and the images may be reordered, filtered, selected, saved, deleted and edited in an optimal manner.

Digital photography encourages users to photograph as many images as they wish, without the expense of film nor the effort of developing the film. A limitation is the finite capacity of digital storage either in the removable memory card or the memory permanently attached to the camera. While traveling, for instance, a user typically deletes from storage poor quality photographic images and/or duplicate photographic images. A decision to delete a photographic image from storage is usually based on inspecting the image on a small display, typically of one to two inches. Environmental conditions, such as sunlight, interfere with proper viewing of the displayed image. Consequently, the decision to delete a photographic image from memory is not necessarily the best decision causing desired images to be deleted and less desirable images to be kept.

There is thus a need for, and it would be highly advantageous to have a system and method for filtering, selecting, saving, deleting and re-ordering digital images in a digital camera.

There is considerable prior art in the field of digital photography and improving performance therein. U.S. Pat. No. 6,822,657 discloses a method and apparatus for improving image quality in a digital imaging device such as a digital video or still camera. The method for improving image quality includes providing a digital image signal, and selecting a color corrector based on a signal-to-noise ratio of the digital image signal. The method optimizes the image quality of an electronic output image output over a range of signal values.

U.S. Pat. No. 6,885,395 discloses a method for selectively adjusting the resolution levels or the quality levels of digital images stored in a memory of a digital camera having a predetermined memory space.

U.S. Pat. No. 6,812,969 discloses a digital camera in which the user can easily recognize that an image is out of focus by viewing a display image. At the time of live display, image capturing is performed at predetermined time intervals and are successively recorded in memory. An evaluation value is calculated indicative of the focus state of the image. When the image is out of focus, an image quality degrading process is performed and an image of low image quality is displayed.

US patent application publication 20020110286 discloses a camera with two camera systems The first camera system is a high resolution camera which captures images (so-called ‘key frames’) at a relatively low rate, and the second camera system is a low resolution camera which captures images (so-called ‘video frames’) at a higher rate. Video frames are captured between each key frame. An application program is provided, either in a PC to which the frames are downloaded, or in the camera itself. The main purpose of the application program is to decide which of the captured frames should be stored, and which should be discarded (i.e. by a deletion or replacement operation) thereby freeing-up memory. This is performed by means of the application program performing an analysis of the image content in the frames, assigning a quality factor to the image content based on the composition quality of the image content, and updating memory to remove frames which have a quality factor indicating a lower composition quality than a subsequently captured frame. Thus, only those frames having ‘interesting’ content will be saved, and those frames which are poor in terms of their content or composition will not occupy memory if a better frame is identified.

US patent application publication 20040119876 discloses displaying an image according to a digital signal after the user takes a picture. The image data is analyzed by digital signal processing to determine picture quality. When it is determined that the picture quality is inadequate, the user is informed of information regarding the quality of the picture.

US patent application publication 20040212689 discloses an image-capturing apparatus, capable of performing image-quality correction on a captured image. A camera system detects a read image signal which is read by thinning out pixels by an image-capturing device Based on the detected data, control values for image-quality correction are computed in a microcomputer, and the camera system performs an image-quality correction process on the image signal based on the control values.

US patent application publication 20040213434 discloses a document processing method for using image quality to sort documents.

PCT patent application publication WO9967743 discloses an image correcting method and a digital image inputting device such as a digital camera or a video camera, in which various aberrations of an image forming optical system and errors in the color conversion function of an image sensor are corrected by digital techniques.

PCT application publication WO2004030378 relates to an electronic camera including a solid state imaging device and provides an image processor adapted to calculate a quality parameter and for controlling and signaling the quality parameter to an operator of the camera. The quality of the recorded image may be based on a histogram of image pixel values.

All prior art references as cited above are included herein by reference for all purposes as if entirely set forth herein.

### SUMMARY OF THE INVENTION

Unless otherwise indicated, the term “attached” as used herein refers to both permanently attached and removably attached.

The term “filtering” as used herein refers to ordering and/or deleting photographic images based on a parameter of the photographic images.

According to the present invention there is provided a system which includes a digital camera with attached memory. The camera photographs and stores in the memory stored images. The camera includes a grading mechanism which assigns respectively values to each of the stored images based on parameters of the stored images. The camera further includes a display mechanism which displays the stored images in a nominal order; and an input mechanism which triggers the camera to display the stored images in an order, other than the nominal order, based the assigned values. Preferably, the grading mechanism includes a processor which controls the memory and/or the camera. Preferably, the memory is removable from the digital camera and the processor is permanently attached to the memory. Preferably, the parameters include focus quality, brightness, sharpness, contrast, and image size. Preferably, the assigned value is calculated based on more than one parameter. Preferably, the system stores in memory reference values for the parameters and the assigned values are calculated relative to the reference values. Preferably, the display mechanism further displays the assigned values.

According to the present invention there is provided a method for displaying stored photographic images photographed with a digital camera. with the photographic images stored in memory attached to the digital camera. The photographic images are graded and values are assigned respectively to each of the images based on the image parameters. The stored images are displayed in a nominal order. The camera is triggered to display the stored images in an order, other than the nominal order, based respectively on the assigned values. Alternatively, one or more of the stored images is automatically deleted based on the assigned values or otherwise deleted by a user of the digital camera who inputs an instruction either to perform the deletion; or ignore, thereby bypassing the deletion. Preferably, the expected improvement of the assigned values is calculated by applying a correction algorithm. Preferably, a user selectably inputs an instruction to either perform the improvement and approve the assigned value or ignore and bypass the improvement when the algorithm does not sufficiently improve the assigned value. Preferably, prior to calculating and applying the correction algorithm, the user of the digital camera inputs a standing instruction to automatically perform the calculation and apply the correction algorithm to the stored images.

According to the present invention there is provided a method for displaying a plurality of photographic images photographed with a digital camera. The photographic images are stored in memory attached to the digital camera. The method includes calculating a photographic parameter for each of the stored images and triggering the digital camera to display the images in an order based on the photographic parameter such as a quality value, a correlation of the photographic images and a photographic image coloration. Preferably, the photographic images are re-ordered and/or deleted based on the photographic parameter.

According to the present invention there is provided a system which includes a digital camera with attached memory. The camera photographs and stores images in the memory. The camera includes a grading mechanism which assigns respectively values to each of the stored images based on parameters of the stored images. The digital camera includes a delete mechanism which deletes one or more of the stored images based on the assigned values.

According to the present invention there is provided a method for deleting at least one stored image from a plurality of stored photographic images photographed with a digital camera. The photographic images are graded by respectively assigning one or more values to the images base on the image parameters. One or more of the stored images are deleted based on the assigned values. Preferably, the deletion is performed by a user of the digital camera who inputs an instruction to either perform the deletion; or to) ignore, thereby bypassing the deletion. Alternatively, the deletion is performed automatically.

### BRIEF DESCRIPTION OF THE DRAWINGS

The invention is herein described, by way of example only, with reference to the accompanying drawings, wherein:

FIG. 1 is a simplified flow diagram of a process for filtering, correcting and reordering digital images according to an embodiment of the present invention;

FIG. 2 is a simplified flow diagram of a process for grading stored photographic images in a digital camera, according to an embodiment of the present invention;

FIG. 3 is a simplified flow diagram illustrating a process for correcting images in a digital camera, according to an embodiment of the present invention; and

FIG. 4 is a simplified system diagram of a digital camera, according to an embodiment of the present invention.

### DESCRIPTION OF THE PREFERRED EMBODIMENTS

The principles and operation of a system and method of filtering digital images, according to the present invention, may be better understood with reference to the drawings and the accompanying description.

Before explaining embodiments of the invention in detail, it is to be understood that the invention is not limited in its application to the details of design and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

By way of introduction, a principal intention of the present invention is to characterize images stored in a digital camera, to display the stored images in a specific order and to select appropriate images for deletion thereby freeing memory for further photography. The present invention provides tools for parameterizing image quality of a stored photographic image and comparing the image quality to that of another similar stored image. The image quality pertaining to specific parameters may be calculated by a processor in the camera or by a processor controlling the memory card attached to the camera. The user of the camera may choose to delete the stored images of poorer quality or just re-order the images based on the specific parameters.

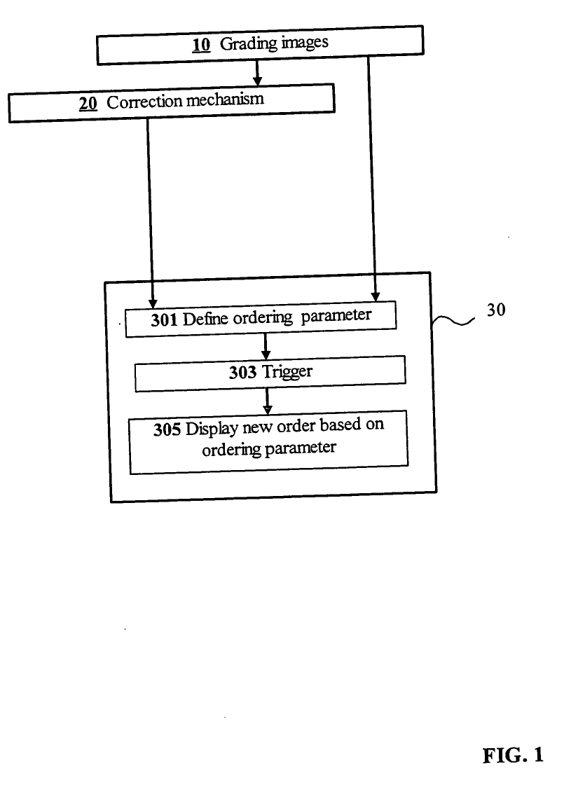

Referring now to the drawings, FIG. 1 illustrates a method including three stages, a first process 10 for grading images, an optional second process 20 for improving or correcting images and a third process 30 for displaying pictures in a new order based on criteria other than or in addition to the chronological order of the photography.

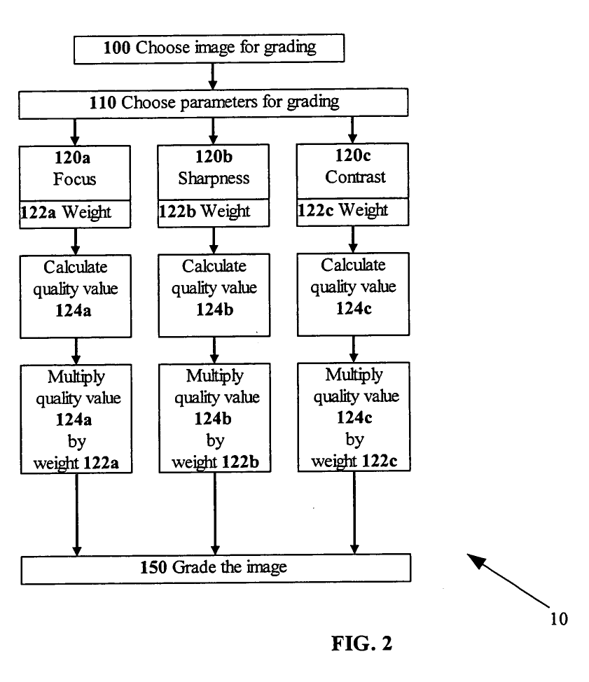

Reference is now made to FIG. 2, which illustrates, in more detail, process 10 for grading images. In process 10, a previously stored photographic image is chosen (step 100) for grading. Quality parameters 120 are chosen (step 110) or are previously defined as criteria for grading. Quality parameters 120 include for example focus 120a, sharpness 120b, contrast 120c, and image size (not shown) e.g. in pixels. Quality parameters 120 are prioritized by assigning respectively a weight 122 associated with each quality parameter 120. Quality values 124 corresponding to each quality parameter 120 are calculated for each image. The images are graded (step 150) for each quality parameter 120 by multiplying the calculated quality value 124 by weight 122 of quality parameter 120. For example focus 120a is given the highest priority with weight 122a of 5, sharpness 120b has a weight 122b of 4, and contrast 120c is given weight 122c of 2. Quality of focus 120a of a stored photographic image is calculated and multiplied by weight 122a of focus parameter 120a, to determine quality value 124a for focus parameter 120a. The photographic image is typically graded (step 150) by taking into account several quality values 124. The grade assigned (step 150) to the image quality is preferably related to the difference between calculated image quality values 124 and previously stored threshold values used to define the minimal acceptable quality for the quality parameters 120. The total grade for quality is related to the sum of the quality values for the specific parameters. One suitable function is the variance, i.e. the sum of the squares of the differences between quality values 124 and the corresponding threshold values.

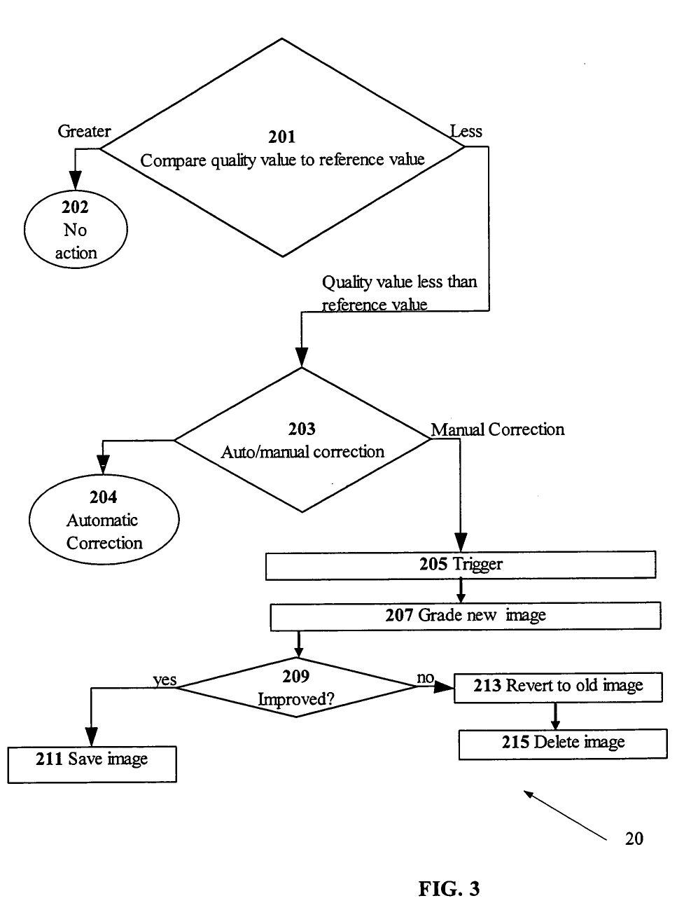

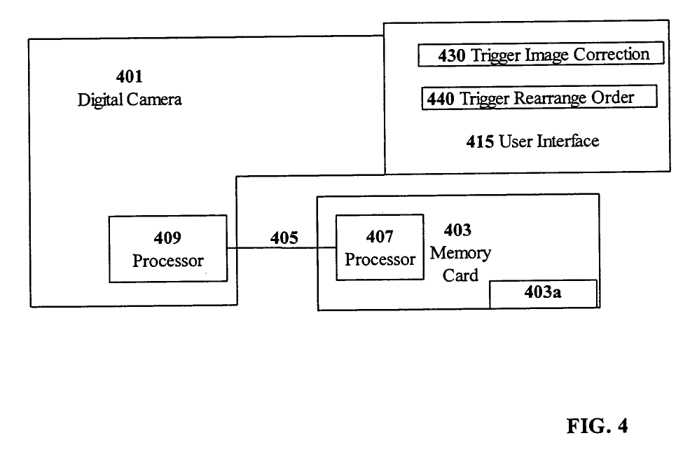

In some embodiments of the present invention, the camera further includes automatic correction mechanism 20 for improving image quality as illustrated in FIG. 3. Typically, quality parameters 120 are calculated and in decision block 201 quality value 124 is compared with the previously stored threshold value or the reference value. If quality value 124 is greater than the previously stored referenced value (decision block 201) then typically no action is taken (step 202). Otherwise, if quality value 124 is less than the previously stored reference value, then an option exists (in decision block 203) to attempt improving the image with a previously stored algorithm. The correction mechanism is performed automatically (step 204) such as with a standing instruction by the user or manually. Improving the image is typically performed manually by the user with a button or input mechanism 430 (referring to FIG. 4) which triggers (step 205) the correction algorithm. Preferably, the image is graded again (step 207) using grading process 10 after attempting to improve the photographic image. If the correction algorithm was effective in improving the image (decision block 209) then the new improved image is typically saved. (step 211) If the correction algorithm was ineffective in improving the image then the correction may be reversed; typically the corrected image is not saved and the saved image reverts back (step 213) to the original photographic image, prior to the improvement attempt. At this point, the user optionally may delete (step 215) the image.

Referring back to FIG. 1, in process 30 the images are rearranged in a display order other than the default arrangement, e.g. the order in which the images were photographed. An order parameter is defined (step 301) which determines the order of the images and a trigger (step 303) is used to change (step 305) the order. There are many order parameters that can be selected (step 301) to display (step 305) a different order. For instance, if the user wishes to compare or correlate several nearly identical images and delete some of the nearly identical images, order parameters may include the chronological order of photographing as an order parameter followed by an image-correlation parameter for grouping similar images. The group of similar images can be displayed (step 305) on the camera display at the same time, or sequentially. The stored images may be reordered (step 305) based on the dimensions of objects in the images, based on coloration and/or based on quality parameters, e.g. quality of focus.

FIG. 4 illustrates digital camera 401 with a removable memory card 403. Memory card 403 includes a camera interface 405, which interfaces conventionally with digital camera 401. Digital camera includes a user interface 415. User interface 415 includes conventional controls and monitors for operating a conventional digital camera. Typically, quality parameters 120 and quality values 124, are displayed conventionally by user interface 415 to the user. Digital camera 401 further includes an input mechanism 430 for process 20 (decision block 203) to initiate an image improvement algorithm either automatically or manually. User interface 415 typically includes a display trigger 440 to rearrange the order of the images based on the ordering parameter. For example, pressing display trigger button 440 twice in less than 1 second may switch the order to display similar images based on an image correlation algorithm stored in memory 403. A different trigger 440 may switch the order to display according to grading of image quality.

A portion of memory 403a, for instance in memory card 403 is reserved for storing various algorithms required for different embodiments of the present invention. Stored algorithms include processing algorithms for correlating images, correction algorithms for improving the images and specific formats for rearranging the order for displaying the images according to specific parameters. Processing parameters for correlating and improving images are also typically stored in memory 403a, and images. Stored algorithms are either run on a processor 407 which controls memory card 403 or by processor 409 which controls digital camera 401.

While the invention has been described with respect to a limited number of embodiments, it should be understood by persons skilled in the art that the present invention is not limited by what has been specifically shown and described herein. Rather, the scope of the present invention includes both combinations and sub-combinations of the various features described herein, as well as variations and modifications which might occur to persons skilled in the art upon reading the specification and which are not in the prior art.

While the invention has been described with respect to a limited number of embodiments, it will be appreciated that many variations, modifications and other applications of the invention may be made.

What is claimed is:

1. A system comprising:
(a) a digital camera which photographs and stores in memory a plurality of stored images, said memory attached to said digital camera; and
(b) a grading mechanism which assigns respectively at least one value to each of said stored images based on at least one parameter of said stored images;
wherein said digital camera includes:
(i) a display mechanism which displays said stored images in a nominal order; and
(ii) an input mechanism which triggers said camera to display said stored images in an order, other than said nominal order, based on said at least one value.

2. The system, according to claim 1, wherein said grading mechanism includes a processor which controls said memory.

3. The system, according to claim 2, wherein said memory is removable from said digital camera and wherein said processor is permanently attached to said memory.

4. The system, according to claim 1, wherein said grading mechanism includes a processor which controls the digital camera.

5. The system, according to claim 1, wherein said at least one parameter is selected from the group consisting of: focus quality, brightness, sharpness, contrast, and image size.

6. The system, according to claim 1, wherein said at least one parameter includes at least two parameters and wherein said at least one value is calculated based on said at least two said parameters.

7. The system, according to claim 1, wherein said system stores in said memory at least one reference value for said at least one parameter and wherein said at least one value is calculated relative to said at least one reference value.

8. The system, according to claim 1, wherein said display mechanism further displays said at least one value.

9. A method for displaying a plurality of stored photographic images photographed with a digital camera, the method comprising the steps of:
(a) providing the digital camera with the photographic images stored in memory attached to the digital camera;
(b) grading the photographic images thereby assigning respectively at least one value respectively to each of said images based on at least one image parameter;
(c) displaying the stored images in a nominal order; and
(d) triggering said camera to display said stored images in an order, other than said nominal order, based on said at least one value.

10. The method, according to claim 9, further comprising the step of:
(c) deleting at least one of the stored images based on said at least one value.

11. The method according to claim 10, wherein said deleting is automatic.

12. The method according to claim 10, further comprising the step of:
(d) selectably inputting by a user of the digital camera an instruction either to:
(i) perform said deleting; or
(ii) ignore, thereby bypassing said deleting.

13. The method, according to claim 9, further comprising the step of:
(c) calculating the expected improvement of said at least one value by applying a correction algorithm.

14. The method, according to claim 13, further comprising the step of:
(d) selectably inputting by a user of the digital camera an instruction either to:
(i) perform said improvement, thereby improving said at least one value; or
(ii) ignore, thereby bypassing said improvement.

15. The method, according to claim 13, further comprising the step of, prior to said calculating:
(d) inputting by a user of the digital camera a standing instruction to automatically perform said calculating to said stored images.

16. A method for displaying a plurality of photographic images photographed with a digital camera, wherein the photographic images are stored in memory attached to the digital camera, the method comprising the steps of:
(a) calculating at least one photographic parameter for each of said stored images; and
(b) triggering the digital camera to display the images in an order based on said at least one photographic parameter selected from the group consisting of:
(i) at least one quality value;
(ii) a correlation of the photographic images;
(iii) photographic image coloration.

17. The method, according to claim 16, further comprising the step of:
(b) filtering the photographic images based on said at least one photographic parameter.

18. The method, according to claim 16, further comprising the step of:
(b) deleting at least one of the photographic images based on said at least one photographic parameter.

19. A system comprising:
(a) a digital camera which photographs and stores in memory a plurality of stored images, said memory attached to said digital camera; and
(b) a grading mechanism which assigns respectively at least one value to each of said stored images based on at least one parameter of said stored images;
wherein said digital camera includes a delete mechanism which deletes at least one of said stored images based on said at least one value.

20. A method for deleting at least one stored image from a plurality of stored photographic images photographed with a digital camera, the method comprising the steps of:
(a) providing the digital camera with the photographic images stored in memory attached to the digital camera;
(b) grading the photographic images thereby assigning respectively at least one value respectively to each of said photographic images based on at least one image parameter; and
(c) deleting the at least one of said stored images based on said at least one value.

21. The method, according to claim 20, further comprising the step of, prior to said deleting:
(d) selectably inputting by a user of the digital camera an instruction either to:
(i) perform said deleting; or
(ii) ignore, thereby bypassing said deleting.

22. The method, according to claim 20, wherein said deleting is performed automatically.
